(19) United States
(12) Patent Application Publication
(10) Pub. No.: US 2016/0255971 A1
(43) Pub. Date: Sep. 8, 2016

(54) DEVICE FOR POSITIONING HANGING ITEMS

(71) Applicant: ANGELA CAMERON, North Vancouver (CA)

(72) Inventor: ANGELA CAMERON, North Vancouver (CA)

(21) Appl. No.: 14/636,176

(22) Filed: Mar. 2, 2015

(51) Int. Cl. A47G 1/20; G01B 11/27; G01B 3/10; G01C 9/24

(52) U.S. Cl. CPC A47G 1/205; G01C 9/24; G01B 11/27; G01B 3/1084; G01B 2003/1089

(57) ABSTRACT

Examples of a device for hanging multiple items on a structure are disclosed. The device comprises an elongated body with a planar configuration and a first opening in the body in proximity to one of its ends. The opening is shaped and sized so that it can fit over a hardware, such as a screw or nail, that penetrates into the structure. One or more additional markings are formed in the body at a pre-determined distance from the first opening. The hardware at the first opening holds the end of the device in place so that the body can be placed against the structure and extended in a desired direction to mark position of a next item by registering it with a position of the one of the additional markings.

### TECHNICAL FIELD

The present disclosure relates generally to a device for use in hanging wall supported items and more particularly to device for aiding in positioning multiple hanging items on a wall.

### BACKGROUND

Unless otherwise indicated herein, the materials described in this section are not prior art to the claims in this application and are not admitted to be prior art by inclusion in this section.

Mounting picture frames on a wall is time-consuming and it may require involvement of more than one person or multiple tools and multiple steps. For example, a user need to measure a distance at which the frames should hang out, scribe pencil marks on the wall, check/adjust the alignment between the multiple marks and then insert a hardware, such as nails or screws, at respective marked positions on the wall surface. Unfortunately, mounting the items may turn out to be a trial and error process and the person may have to re-adjust everything if the hangers are not correctly placed. Even if the hangers have been correctly spaced apart, they may not be perfectly leveled.

The process of hanging items on a wall structure may become even more time consuming and cumbersome process when more than two items need to be hung on and especially when such plurality of items are hung in a specific design pattern involving alignment in horizontal, vertical and/or diagonal directions.

Therefore, it would be desirable to have a wall mounting device that is inexpensive and simple to use so that a person may use it to precisely and correctly hang up multiple items on a wall or any other vertical structure in a desired design pattern without need to measure the space between the items or hold the items up against the wall surface during operation of marking or inserting the hardware.

### SUMMARY

In one aspect, a device for hanging multiple items on a structure is provided. The device comprises an elongated body with a planar configuration and a first opening formed in the body in proximity to one of its ends. The opening is shaped and sized to fit over a hardware that penetrates into the structure. One or more additional markings are formed in the body at a pre-determined distance from the first opening. The hardware holds in place the end of the device at the first opening so that the body can be placed against the structure and can extend in a desired direction to mark position of a next hanging item using one of the additional markings

The one or more additional markings are additional openings formed in the body along its length at predetermined distance from the first opening. The first opening and the one or more additional openings are positioned at a same longitudinal axis along the length of the body.

In one aspect, the one or more additional markings are notches formed at an edge of the body and positioned at a predetermined distance from the first opening. The first opening and a tip of the one or more notches are positioned at a same longitudinal axis along the length of the body.

The device further comprises an align means that are configured to level the multiple hanging items. The align means comprises at least one of a bubble tube or a light beam optical system configured to provide straight leveling light line.

In another aspect, a method for precisely positioning multiple items on a structure is provided. The method comprises the steps of securing a first hardware at a pre-determined position on the structure; positioning an aiding device for positioning multiple items so that a first opening that is formed in its elongated body is placed over the first hardware such that first hardware holds in place one end of the device; placing the device against the structure and extending the body of the device in a desired direction in which the multiple items need to be hung; marking a precise position of next items using one or more additional markings formed in the body along its length; moving the device away from the structure and installing additional hardware at the marked positions for hanging the additional items.

In addition to the aspects and embodiments described above, further aspects and embodiments will become apparent by reference to the drawings and study of the following detailed description.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure. Sizes and relative positions of elements in the drawings are not necessarily drawn to scale. For example, the shapes of various elements and angles are not drawn to scale, and some of these elements are arbitrarily enlarged and positioned to improve drawing legibility.

FIG. 1 is a perspective view of an example of a device for use in hanging multiple items on a structure;

FIG. 2 illustrates an example of multiple items hung up in one design pattern using the device of FIG. 1.

### DETAILED DESCRIPTION OF SPECIFIC EMBODIMENTS

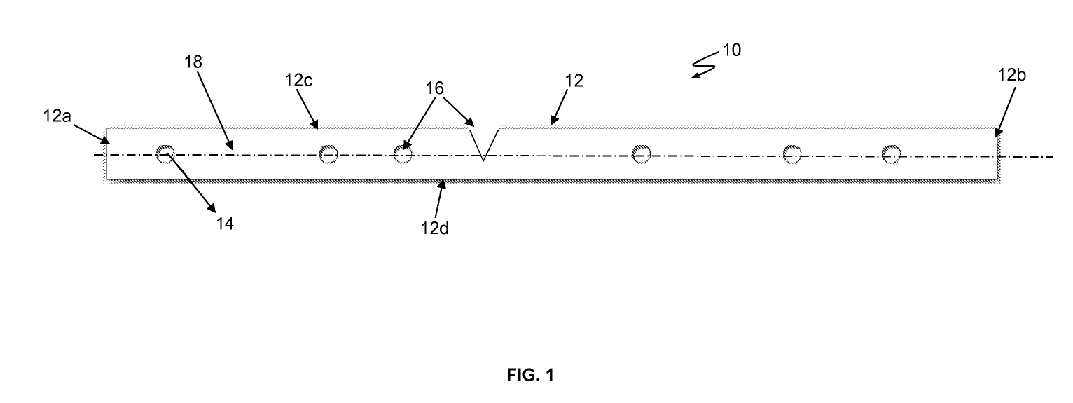

FIG. 1 shows an example of a device 10 used in hanging multiple items on a structure such as for example a wall. The device 10 comprises an elongated body 12 with a first end 12a, a second end 12b, a top edge 12c and a bottom edge 12d. The body 12 extends between the first and the second ends 12a and 12b. The body 12 has a relatively planar configuration so that it can be placed against the wall during operation of marking the position of the items on the wall/structure. The body 12 can be made of a rigid material such as any suitable plastic or metal material or can be made of a flexible material such as a paper, textile, plastic or any other suitable bendable material without departing from a scope of the invention. A first opening 14 is formed in the body 12 in proximity to one of the ends 12a or 12b. The opening 14 can be a hole cut through the body 12. The opening 14 can be sized and shaped so that it can fit over a suitable hardware (e.g. screw or nail). For example, the opening 14 can have various sizes and shapes, e.g. a circular, oblong, rectangular or any other shape, so that a head of the hardware can pass through the opening 14. The hardware is first secured at a pre-determined position on the wall and the opening 14 can be placed over the hardware so that the device 10 can hang on the hardware. Once one end of the device 10 is secured to the wall at the opening 14, the hardware can hold that end of the device 10 in place thus avoiding the need of the user holding the device 10 pressed against the wall. So, the user can take the opposite end of the device 10, e.g. second end 12b, and extend the body 12 against the wall in a desired direction. For example, the body 12 can be extended in horizontal direction away from the hardware holding the device at the first opening 14 if the items to be hung are supposed to lay in a horizontal line design pattern. If the items are supposed to lay one above another in vertical direction then the body 12 is extended in vertical direction away from the first opening 14. In one implementation, the device 10 can be positioned against the wall so that the first opening 14 is at a desired, pre-determined position and then the hardware can be inserted through the opening 14. In another implementation, the hardware can penetrate through the body 12 and into the wall thus in situ forming the first opening 14.

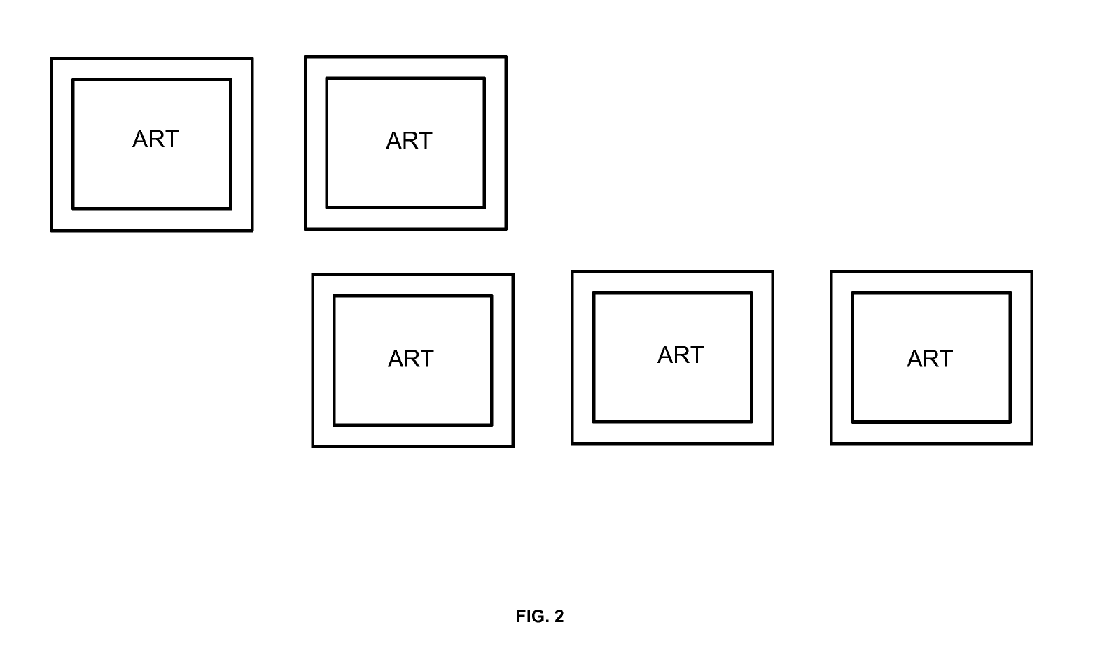

The device 10 further comprises one or more additional markings 16 formed in the body 12. The one or more additional markings 16 are formed in the body 12 at a fixed and pre-determined distance from the opening 14 to mark a position of the next items. The additional marking 16 can be an additional opening (hole) 16 formed in the body 12. As illustrated in FIG. 1, plurality of such additional openings 16 can be provided along the length of the elongated body 12 at a certain pre-defined distance one from another. The additional openings 16 can have the same size and/or shape and can be positioned at the same distance from the edges 12c and 12d as the first opening 14 so that the opening 14 and additional openings 16 are aligned at the same longitudinal axis 18. In one implementation, the openings 16 can have different sizes and shapes but all such openings 16 should be arranged along the same longitudinal axis with the first opening 14. The additional markings 16 can be used so that an additional hardware can be aligned with the marking 16 to mark and hang additional items. In one embodiment, the marking 16 can be a notch made on one of the edges 12c, 12d of the body 12. For example, the additional marking 16 can be a V-notch 16a. A tip 17 of such additional notch 16a can sit on the same longitudinal axis, e.g. longitudinal axis 18, as the opening 14, so that the additional hangers can be leveled with the hardware that passes through the first opening 14. “Tip” of the notch is defined as an end 17 of the notch (FIG. 1) that is away from the edge 12c and that defines the depth of the notch 16a. In one implementation, some of the additional markings can be designed as notches 16a while the other as holes 16 without departing from the scope of the invention. The distance between the first opening 14 and the additional markings 16, 16a, and/or distance between the neighboring markings 16, 16a can be the same or can differ depending on the size of the items, e.g. size and shape of the frames and the desired pattern according to which the user wants to hang such items. The items to be hung up can have different sizes or can be arranged in different design patterns using the aiding device 10. For example, FIG. 2 shows examples of art frames that can be easily mounted on a wall in various design patterns using the device 10. Based on the size of the art frames and the desired space between each of the art frames the user determines the distance between the opening 14 and each of the markings 16, 16a. Then based on such pre-determined distances the user can form the markings 16, 16a by perforating/cutting the body 12. In one implementation, the markings 16, 16a can be pre-manufactured for various standard sized frames or by providing frequent markings spaced apart at small distance one from another, such as for example providing markings 16, 16a at every few centimeters/inches distance.

In one implementation, the body 12 can further includes length measuring scale (e.g. millimeter/centimeters, inch/feet, etc.) that is provided at a face surface of the body 12 so that the user can measure the distance between two markings or between the first opening 14 and markings 16, 16a or between any two or more points along the length of the body 12. In order to allow the items to be leveled properly, an alignment means (not shown) can be provided as well. The alignment means can include a levelling “bubble” tube and/or an optical system such as a laser system that can provide light line on the wall. The alignment means can be integrated with the device 10 or can be separate from the device 10. For example, once the device 10 is placed against the wall its position can be adjusted using either the integrated aligning means or some external alignment means (e.g. leveling app of user's smart phone). The external alignment means can be brought into line with the device edge 12c, 12d and the device 10 is leveled so that the one or more markings 16 and the first opening 14 are aligned in the desired direction.

In one mode of operation, the user can insert the hardware in the wall at a height and a lateral point at which he/she wants to position the first item. Then the first opening 14 is placed over such hardware to register with the first item position. Then the body 12 is placed against the wall in a desired direction, such as for example in horizontal direction (parallel to the wall's bottom/top) or vertical direction with respect to the wall's bottom/top. The alignment means are used to ensure that the body 12 is leveled in the desired direction. Then the user can mark a position of the next items using the one or more markings 16, 16a. The user may choose first to mark the next items' positions using a pencil scribble or can insert hardware directly by registering such hardware with the corresponding markings 16, 16a. In one implementation, the first opening 14 is put over the first hardware and the marking 16, 16a is used to position the additional hardware for the next item. Then the device 10 can be repositioned by positioning the opening 14 over the additional hardware and mark the position of the next additional hardware using the same marking 16, 16a. Consequently, more than two items can be precisely positioned using an example of the device 10 with only one additional marking 16, 16a in addition to the first opening 14. When the user want to place a next item in vertical or diagonal direction (see FIG. 2), the body 12 is placed against the wall in the desired vertical/diagonal direction and the position of the next item is marked using the marking 16, 16a. In this manner, it is possible to install plurality of items, e.g. arts, so that the items can hang at the desired position and orientation.

While particular elements, embodiments and applications of the present disclosure have been shown and described, it will be understood, that the scope of the disclosure is not limited thereto, since modifications can be made without departing from the scope of the present disclosure, particularly in light of the foregoing teachings. Thus, for example, in any method or process disclosed herein, the acts or operations making up the method/process may be performed in any suitable sequence and are not necessarily limited to any particular disclosed sequence. Elements and components can be configured or arranged differently, combined, and/or eliminated in various embodiments. The various features and processes described above may be used independently of one another, or may be combined in various ways. All possible combinations and sub-combinations are intended to fall within the scope of this disclosure. Reference throughout this disclosure to “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the inventions described herein.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

The example calculations, simulations, results, graphs, values, and parameters of the embodiments described herein are intended to illustrate and not to limit the disclosed embodiments. Other embodiments can be configured and/or operated differently than the illustrative examples described herein. Indeed, the novel methods and apparatus described herein may be embodied in a variety of other forms; furthermore, various omissions, substitutions and changes in the form of the methods and systems described herein may be made without departing from the spirit of the inventions disclosed herein.

1. A device for hanging multiple items on a structure, the device comprising:
an elongated body having a first end, a second end and a top and a bottom edges, the body having a planar configuration;
a first opening formed in the body in proximity to one of its ends, the opening being shaped and sized so that a hardware that penetrates into the structure secures the body to the structure at the first opening to mark a position of a first item; and
one or more additional markings formed in the body at a pre-determined distance from the first opening to mark a position of an additional item.

2. The device of claim 1, wherein the one or more additional markings is an opening formed in the body along its length at predetermined distance from the first opening, the first opening and the one or more additional openings laying at a same longitudinal axis along the length of the body.

3. The device of claim 1, wherein the one or more additional marking is a notch formed at an edge of the body, the one or more notches being at predetermined distance from the first opening, the first opening and a tip of the one or more notches laying at a same longitudinal axis along the length of the body.

4. The device of claim 1, wherein the one or more additional markings are one or more openings and one or more notches.

5. The device of claim 1, wherein the body is configured as a measuring tape.

6. The device of claim 5, wherein the body further comprises a length measuring scale formed at a face surface.

7. The device of claim 1, further comprising an align means configured to level the multiple items, the align means comprising at least one of a bubble tube or a light beam optical system.

8. A method of precisely positioning multiple items to a structure using a device for precisely marking a position of the multiple items, the method comprising the steps of:
securing a first hardware into the structure and placing a first opening formed at one end of an elongated body of the positioning device such that the device is secured to the structure at the first opening;
extending the body of the device against the structure in a desired direction;
marking a precise position of next items using one or more additional markings formed in the body along its length at a pre-determined distance from the first opening;
removing the device away from the structure; and
installing additional hardware at the marked positions for positioning additional items.
